(19) United States
(12) Patent Application Publication
(10) Pub. No.: US 2023/0037193 A1
(43) Pub. Date: Feb. 2, 2023

(54) WIND POWER OUTPUT INTERVAL PREDICTION METHOD

(71) Applicant: DALIAN UNIVERSITY OF TECHNOLOGY, Dalian (CN)

(72) Inventors: Jun ZHAO, Dalian (CN); Tianyu WANG, Dalian (CN); Wei WANG, Dalian (CN)

(21) Appl. No.: 17/774,735

(22) PCT Filed: Aug. 3, 2021
(86) PCT No.: PCT/CN2021/110202

§ 371 Date: May 5, 2022

(30) Foreign Application Priority Data
Jul. 26, 2021 (CN) 202110841635.4

(51) Int. Cl. H02J 3/00; H02J 3/38; H02J 3/46; G05B 19/042

(52) U.S. Cl. CPC H02J 3/004; H02J 3/381; H02J 3/466; G05B 19/042; H02J 2300/28; H02J 2203/20; G05B 2219/2639; G05B 2219/2619

(57) ABSTRACT

The present invention belongs to the technical field of information, particularly relates to the theories such as time series interval prediction, extreme learning machine modeling and Gaussian approximation solution, and is a wind power output interval prediction method. First, interval prediction of wind power output influencing factors is realized by time series analysis and normal exponential smoothing so as to consider an input noise factor. Then an extreme learning machine prediction model is established with an interval result as an input, output distribution is calculated based on iterative expectation and a conditional variance law, and thus an interval prediction result of wind power output is obtained. The method has advantages in interval prediction performance and calculation efficiency and can provide guidance for production, scheduling and safe operation of a power system.

### TECHNICAL FIELD

The present invention belongs to the technical field of information, particularly relates to the theories such as time series interval prediction, extreme learning machine modeling and Gaussian approximation solution, and is a wind power output short-term interval prediction method considering input noise factors. First, interval prediction of wind power output influencing factors is realized by time series analysis and normal exponential smoothing so as to consider an input noise factor. Then an extreme learning machine prediction model is established with an interval result as an input, output distribution is calculated based on iterative expectation and a conditional variance law, and thus an interval prediction result of wind power output is obtained. The method has advantages in interval prediction performance and calculation efficiency and can provide guidance for production, scheduling and safe operation of a power system.

### BACKGROUND

As global energy demand and consumption continue to increase, the development and studies of renewable energy sources such as wind energy, solar energy and biomass energy are increased day by day, and have alleviated the situation of insufficient energy reserves and unreasonable resource structure in more and more fields. Among which, wind power generation has the advantages of small floor area, low environmental influence, abundant resources and high conversion efficiency, so that wind power has been developed rapidly under the background of global resource shortage. However, different from traditional thermal power generation, wind power generation is limited by multiple factors such as wind direction, wind speed and air density, showing a high degree of uncertainty, discontinuity and fluctuation. At the same time, due to influence of factors such as resource distribution, development technology and power grid structure, problems of energy waste and safety are increasingly prominent. (Luo Lin. Study on power distribution network reconfiguration strategy considering uncertainty of new energy generation [D]. (2015). Hunan University).Therefore, accurate wind power output prediction can guarantee safe operation of a power grid to a certain extent and has a great significance to support the operation planning of the power grid, reduce the operation cost of the power grid and maximize the utilization of wind power.

In view of the problem of wind power output prediction, most methods in current literatures are based on data point prediction, which mainly include a grey theory (Li Yingnan. Wind speed-wind power prediction based on grey system theory [D]. (2017). North China Electric Power University), a kernel function method (Naik J, Satapathy P, Dash P K. Short-term wind speed and wind power prediction using hybrid empirical mode decomposition and kernel ridge regression [J]. (2018). Applied Soft Computing, 70: 1167-1188), a time series model (Li Chi, Liu Chun, Huang Yuehui, et al. Study on modeling method for wind power output time series based on fluctuation characteristics [J]. (2015). Power System Technology, 39 (1): 208-214), deep learning (Shahid F, Zameer A, Mehmood A, et al. A novel wavenets long short term memory paradigm for wind power prediction [J]. (2020). Applied Energy, 269: 115098), a combination forecasting method (Hu Shuai, Xiang Yue, Shen Xiaodong, et al. Wind power prediction model considering meteorological factors and wind speed spatial correlation [J]. (2021). Automation of Electric Power Systems, 45 (7): 28-36), etc. The above data point-based prediction models are difficult to effectively reflect uncertainty of wind power output in different weather conditions. Therefore, in this case, prediction results of various points have different degrees of prediction errors, and reliability of the prediction results cannot be explained. An interval prediction result can reflect uncertainty of wind power itself, supplements deficiency of traditional deterministic prediction, and has an important reference value for reasonable scheduling, safe operation, peak adjustment and optimization of a power system. In recent years, methods based on a Monte Carlo method (Yang Mao, Dong Hao. Short-term wind power interval prediction based on numerical weather forecasting and Monte Carlo method[J]. (2021). Automation of Electric Power Systems, 45 (05): 79-85), multi-objective optimization (Jiang P, Li R, Li H. Multi-objective algorithm for the design of prediction intervals for wind power forecasting model[J]. (2019). Applied Mathematical Modelling, 67: 101-122) and neural network (Quan H, Srinivasan D, Khosravi A. Short-Term Load and Wind Power Forecasting Using Neural Network-Based Prediction Intervals[J]. (2017). IEEE Transactions on Neural Networks & Learning Systems, 25 (2): 303-315) have been widely used in wind power output interval prediction. However, all the studies on wind power output interval prediction at home and abroad take measured data as real data to be input into prediction models, without considering influence of input noise, which will reduce the accuracy of wind power output prediction to a certain extent.

### SUMMARY

In order to improve the accuracy and reliability of wind power output prediction, the present invention proposes a wind power output interval prediction method. In order to describe uncertainty caused by the input noise, it is assumed that noise data follows a Gaussian distribution, and interval prediction of wind power output influencing factors is realized by time series and normal exponential smoothing methods. With a prediction interval as an input, a prediction model based on an extreme learning machine (ELM) is established. Considering that distribution of output variables cannot be directly calculated by the ELM due to input data of interval types, an expectation and variance estimation method based on iterative expectation and a conditional variance law is proposed to obtain an interval prediction result of wind power output. An interval prediction result with a smaller average width and a higher coverage probability can be achieved by the interval prediction model, and the interval prediction model can provide more reliable guidance for power system scheduling.

The technical solution of the present invention is as follows:

A wind power output interval prediction method, comprising the following steps:

(1) Obtaining a model training data set, and performing model identification respectively ondifferent influencing factors of wind power output by autocorrelation and partial autocorrelation functions. Estimating parameters according to an akaike information criterion (AIC), and determining the parameters of each prediction model.

(2) Determining a time series prediction model of wind power output influencing factors by sample training, determining an interval prediction result thereof according to training results and improved normal distribution, and testing the output prediction result of the influencing factors.

(3) Adding the interval prediction result of wind power output influencing factors predicted by the time series model to a wind power fitting model as an input, and estimating an expectation value of wind power output prediction according to an iterative expectation law and the ELM.

(4) Solving a variance of a wind power output prediction model according to a conditional variance law. Thus a corresponding wind power output prediction interval can be obtained according to the variance and a given confidence level.

The present invention has the following beneficial effects: the present invention proposes a wind power output interval prediction method. A Gaussian approximation method is used to approximate the distribution of the model by obtaining a total expectation and a total variance of the model, which solves the problem that the distribution of the model is difficult to solve analytically due to uncertainty caused by data noise in an input of the prediction model. It is verified by actual data experiments that the method can obtain a higher prediction interval coverage probability (PICP) and a lower prediction interval normalized average width (PINAW), and has an efficiency advantage on the premise of guaranteeing prediction effect, which can provide more reliable guidance for formulating a power system scheduling solution.

### DESCRIPTION OF DRAWINGS

FIG. 1 is an application flow chart of the present invention.

FIGS. 2A-2F show autocorrelation coefficient diagrams and partial autocorrelation coefficient diagrams of influencing factor data, wherein FIG. 2A is an autocorrelation coefficient diagram of wind speed data; FIG. 2B is a partial autocorrelation coefficient diagram of wind speed data; FIG. 2C is an autocorrelation coefficient diagram of wind direction data; FIG. 2D is a partial autocorrelation coefficient diagram of wind direction data; FIG. 2E is an autocorrelation coefficient diagram of air density data; and FIG. 2F is a partial autocorrelation coefficient diagram of air density data;

FIGS. 3A-3C show comparison diagrams of wind power output interval prediction results under different confidence levels, wherein FIG. 3A is under a confidence level confidence level of 95%; FIG. 3B is at a confidence level of 90%; and FIG. 3C is at a confidence level of 80%;

FIGS. 4A-4C show comparison diagrams of smooth data interval prediction effects obtained by different methods at a confidence level of 80%, wherein FIG. 4A is the present invention; FIG. 4B is method a; and FIG. 4C is method b.

FIGS. 5A-5C show comparison diagrams of fluctuation data interval prediction effects obtained by different methods at a confidence level of 80%, wherein FIG. 5A is the present invention; FIG. 5B is method a; and FIG. 5C is method b.

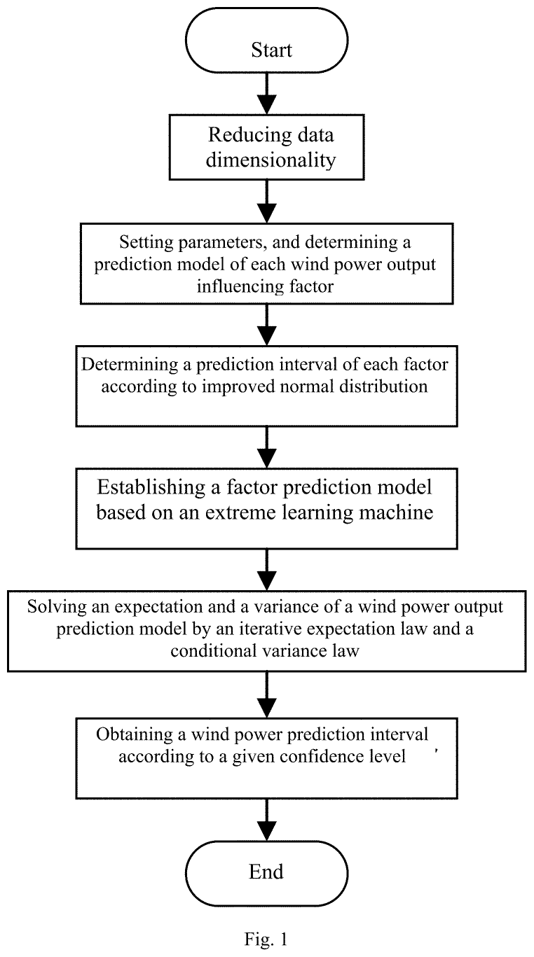

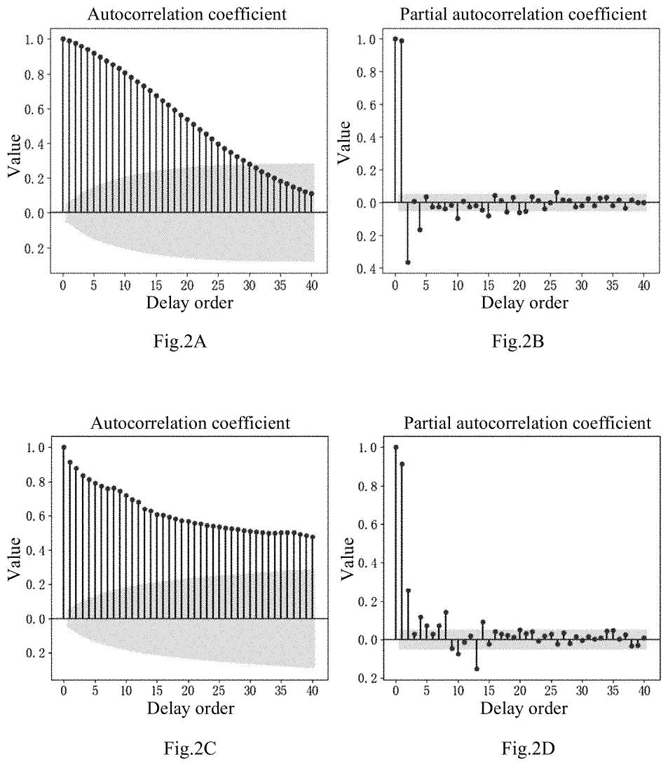

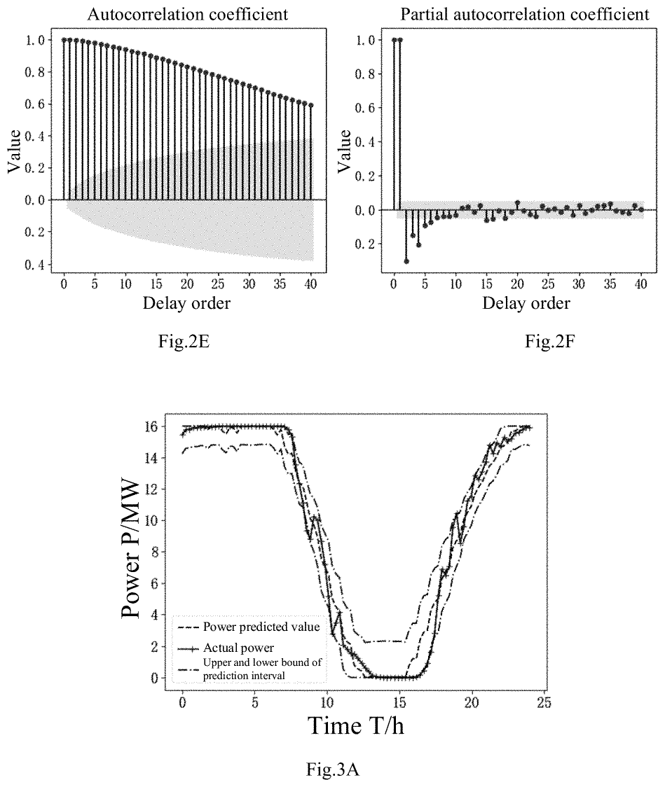

### DETAILED DESCRIPTION

Most traditional wind power output predictions provide deterministic point prediction results for a wind power value at a certain moment in the future, but cannot provide more reference information for uncertainty of wind power. Occurrence of wind energy is characterized by volatility, intermittence and randomness, which leads to complex condition interference of input factors of a prediction model, thus influencing accuracy of wind power output prediction. In order to fully consider noise conditions of the input factors and improve interval prediction effect of wind power output, the present invention proposes an interval prediction model of wind power output based on Gaussian approximation and an extreme learning machine. To better understand the technical route and implementation solution of the present invention, the method is applied to construct an interval prediction model based on data of a wind farm in a domestic industrial park. Specific implementation steps are as follows:

(1) Time Series Model and Parameter Identification

Using an autoregressive moving average model to perform time series prediction on input influencing factors, and an ARMA(p, q) expression is shown as formula (1):

xₜ=β₀+β₁xₜ₋₁+β₂xₜ₋₂+ . . . +βₚxₜ₋ₚ+òₜ+α₁òₜ₋₁+α₂òₜ₋₂+ . . . +α_{q}ò_{t-q} (1)

Where {xₜ} is a smooth time series, p represents an autoregressive order, q represents a moving average order, α is an autocorrelation coefficient, β is a moving average model coefficient, and òₜ is white noise data; using the autocorrelation coefficient and a partial autocorrelation coefficient to perform model identification; if the autocorrelation coefficient of the time series decreases monotonously at an exponential rate or decays to zero by oscillation, i.e. having a trailing property, and the partial autocorrelation coefficient decays to zero rapidly after p step(s), i.e. showing a truncated property, then it is determined that the form of a model is AR(p); if the autocorrelation coefficient of the time series is truncated after q steps, and the partial autocorrelation coefficient has a trailing property, then it is determined that the form of a model is MA(q); if the autocorrelation coefficient of the time series and the partial autocorrelation coefficient do not converge to zero rapidly after a certain moment, i.e. both having a trailing property, then it is determined that the form of a model is ARMA(p, q);

Using an Akaike information criterion to measure fitting degree of an established statistical model, and a definition thereof is shown in formula (2); determining orders p and q of a ARMA(p, q) model according to the Akaike information criterion; calculating the ARMA(p, q) model from low to high, comparing AIC values, and selecting p and q values resulting in a lowest AIC value as optimal model orders;

AIC=2k−2 ln(L) (2)

Where L represents a likelihood function, and k represents a quantity of model parameters;

(2) Interval Prediction of Input Factors Based on Improved Normal Distribution

Obtaining a point estimation of each wind power output influencing factor by prediction with an ARMA model, and obtaining a corresponding interval estimation of a superposition error; defining a point estimation prediction error ε of the ARMA model as a difference between an actual sample value Pᵣ and a model predicted value Pₚ at a certain moment, i.e.:

ε=Pᵣ−Pₚ (3)

Assuming that a wind power output influencing factor prediction error is ε and follows a Gaussian probability distribution with an average value of μ and a variance of σ², which is expressed as:

ε□N(μ,σ²) (4)

A confidence interval under a given confidence level is shown as formula (5), where σ represents a standard deviation; querying a normal distribution table to obtain a coefficient z_{1-α/2}, and substituting the coefficient into the formula to obtain a specific interval range;

[μ−z_{1-α/2}σ,μ+z_{1-α/2}σ] (5)

μ and σ² are leading factors influencing the confidence interval in normal estimation and are determined by errors at the first n moments, therefore, in order to calculate prediction error distribution at moment t+1, it is necessary to set a same weight for all errors from moment t−n+1 to moment t; it can be known from empirical analysis that the closer a moment is to a prediction moment, the greater an influence of an error is, therefore, proportion of the variance of historical prediction errors is decreased exponentially with time by a normal distribution and according to an idea of exponential smoothing and an exponential weighted moving average strategy:

σₜ₊₁²=αεₜ²+(1−α)σₜ² (6)

Where α is a smoothing parameter with a value range of 0 to 1, εₜ is a prediction error at moment t, and σₜ² is an error variance at moment t;

After multiple iterations, formula (6) is expressed as:

σₜ₊₁²=αεₜ²+α(1−α)εₜ₋₁²+α(1−α)²εₜ₋₂²+ . . . +α(1−α)^{t-1}ε₁²+(1−α)^{t}σ₁² (7)

Where if σ₁²=ε₁², then the standard deviation is expressed as σₜ₊₁;

thus, a prediction interval of wind power output influencing factors at a confidence level of 1−α is:

[μ−z_{1-α/2}σₜ₊₁,μ+z_{1-α/2}σₜ₊₁] (8)

(3) Expectation Estimation of Wind Power Output Prediction Based on Iterative Expectation Law and Extreme Learning Machine

Using a Gaussian approximation method based on an iterative expectation law and a conditional variance law to estimate an expectation and a variance of a prediction model; the expectation is used to represent a predicted value at a wind power output point, and the variance is used to describe a wind power output prediction interval, thus to approximately represent distribution of the prediction model;

Giving a group of training samples D={(xᵢ, yᵢ)}ᵢ₌₁^{N}, and assuming that the statistical model for wind power output interval prediction is:

yᵢ=ƒ(xᵢ)+ε(xᵢ) (9)

Where yᵢ represents a wind power target value, a random variable xᵢ={x₁ᵢ, x₂ᵢ, x₃ᵢ} represents the i^{th} input vector and is a wind power output influencing factor prediction result obtained in a previous step, ƒ(xᵢ) represents a wind power predicted value, and ε(xᵢ) represents an observation noise of the wind power target value.

Using an ELM network to obtain an output value ƒ(xᵢ) of the prediction model; According to the iterative expectation law, an estimated value of the prediction model generated at a given input vector x* is μ_{*}, and is expressed as follows:

μ_{*}=E_{x*}(E_{y*}[y*|x*])=ƒ(x*) (10)

Where E(□) represents obtaining an expectation of a variable, and y* is a final power predicted value. A hyperbolic tangent function is used as an activation function h(x) at each node of an ELM network prediction model, as shown in formula (11):

$$h ( x ) = tanh ( x ) = \frac{1 - {e}^{- b \cdot x + c}}{1 + {e}^{- b \cdot x + c}} \qquad ( 11 )$$

Where b and c are parameters of the activation function, and values thereof are determined randomly. Then a corresponding mathematical expression of the ELM network prediction model is shown as formula (12):

$$g ( x ) = {\sum }_{i = 1}^{l} {β}_{i} h ( x ) = {\sum }_{i = 1}^{l} {β}_{i} \frac{1 - {e}^{- {b}_{i} {x}_{i} + {c}_{i}}}{1 + {e}^{- {b}_{i} {x}_{i} + {c}_{i}}} \qquad ( 12 )$$

Where βᵢ is obtained by a singular value method; therefore, an expectation value of a wind power output prediction model is finally expressed as:

$${μ}_{*} = {\sum }_{i = 1}^{l} {β}_{i} \frac{1 - {e}^{- {b}_{i} {x}_{i} + {c}_{i}}}{1 + {e}^{- {b}_{i} {x}_{i} + {c}_{i}}} \qquad ( 13 )$$

(4) Prediction Interval Construction Based on Conditional Variance Law

Obtaining a variance σ_{*}² of the wind power output prediction model according to a conditional variance law and a total variance law, as shown in formula (14):

σ_{*}²=E_{x*}[var_{y*}(y*|x*)]+var_{x*}(E_{y*}[y*|x*]) (14)

Where var(□)represents obtaining the variance of the variable. According to analysis of formula (9), it is considered that yᵢ follows a Gaussian distribution with an expectation of ƒ(xᵢ) and a variance of ε(xᵢ):

yᵢ˜N(ƒ(xᵢ),ε(xᵢ)) (15)

Thus:

E_{x*}[var_{y*}(y*|x*)]=0 (16)

In addition, var_{x*}[E_{y*}(y*|x*)] is expanded as:

var_{x*}[E_{y*}(y*|x*)]=var_{x*}[E(y)]=∫[ƒ(x)−E(ƒ(x))]²p(x)dx (17)

Where ƒ(x) represents a wind power fitting model established by an extreme learning machine; since the ELM network prediction model is a nonlinear model, a first-order Taylor expansion is used to perform linearized approximation thereof:

ƒ(x)=ƒ(x*)+ƒ′(x*)(x−x*)+O(∥x−x*∥²) (18)

Substituting formula (18) into formula (14) to obtain the variance σ_{*}² of the wind power output prediction model, as shown in formula (19):

σ_{*}²=ƒ²(x*)+2ƒ(x*)ƒ′(x*)E(x)−2ƒ(x*)ƒ′(x*)x*+(ƒ′(x*))²(E(x)²−2x*E(x)+x²)−ƒ²(x) (19)

After the expectation and the variance of the wind power output prediction model are obtained, obtaining the wind power output prediction interval at the confidence level of 1−α according to the Gaussian distribution:

$$[ {μ}_{*} - \sqrt{\frac{{σ}_{*}^{2}}{n}} {z}_{α / 2} , {μ}_{*} + \sqrt{\frac{{σ}_{*}^{2}}{n}} {z}_{α / 2} ] \qquad ( 20 )$$

Selecting a prediction interval coverage probability (PICP) and a prediction interval normalized average width (PINAW) as evaluation indexes of interval prediction results, which are defined as:

$$PICP = \frac{1}{n} {\sum }_{i = 1}^{n} {λ}_{i} , PINAW = {\sum }_{i = 1}^{n} \frac{{U}_{i} - {L}_{i}}{nR} \qquad ( 21 )$$

Where n is a quantity of test samples, and R represents a maximum width of the prediction interval; λᵢ is a 0/1 variable, and a formula thereof is as follows:

$${λ}_{i} = \{ \begin{matrix}1 , & {y}_{i} ∈ [ {L}_{i} , {U}_{i} ] \\ 0 , & {y}_{i} ∉ [ {L}_{i} , {U}_{i} ]\end{matrix} \qquad ( 22 )$$

Where yᵢ is a value of the test samples, Uᵢ and Lᵢ are an upper bound and a lower bound of the interval prediction results; if yᵢ is between the upper bound and the lower bound of the prediction interval, λᵢ is 1; if yᵢ falls outside the range of the prediction interval, λᵢ is 0; obviously, the larger the PICP is, the more the actual values contained in the prediction interval are, and the better the interval prediction effect is; in addition, the value of the PICP shall be as close as possible to and higher than the preset confidence level (1−α) in a wind power output interval prediction process; the smaller the value of the PINAW is, the narrower the prediction interval width is, and the better the interval prediction effect is.

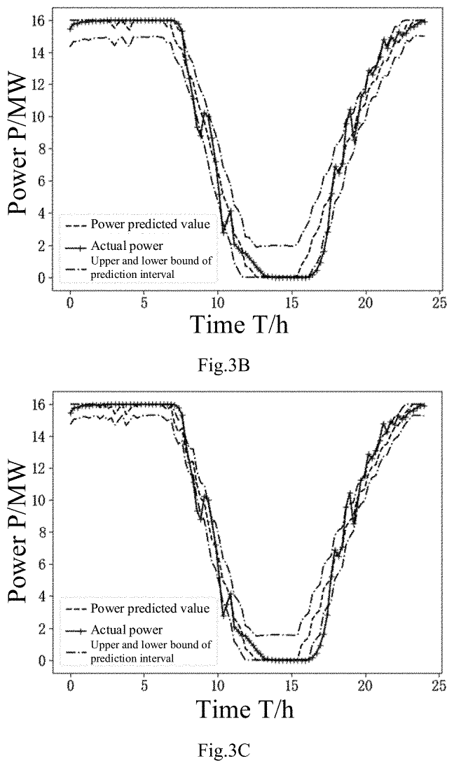

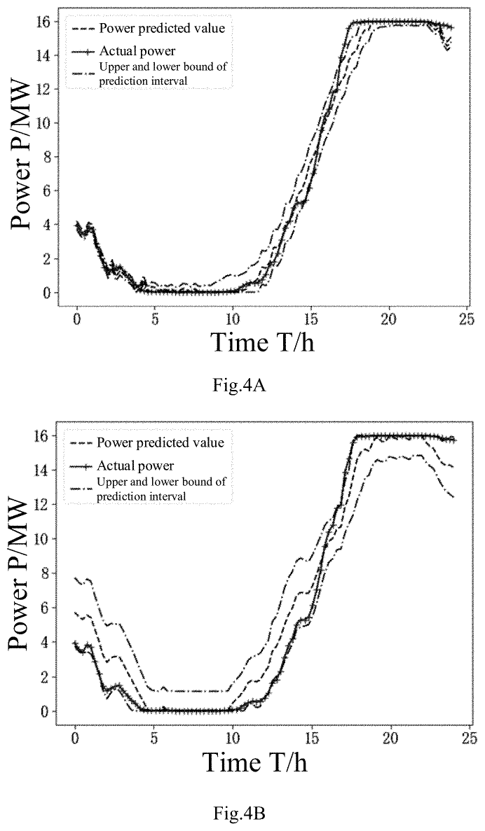

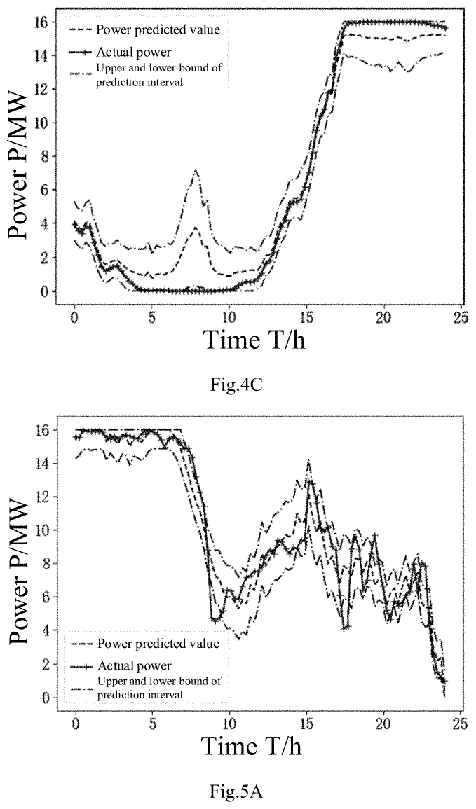

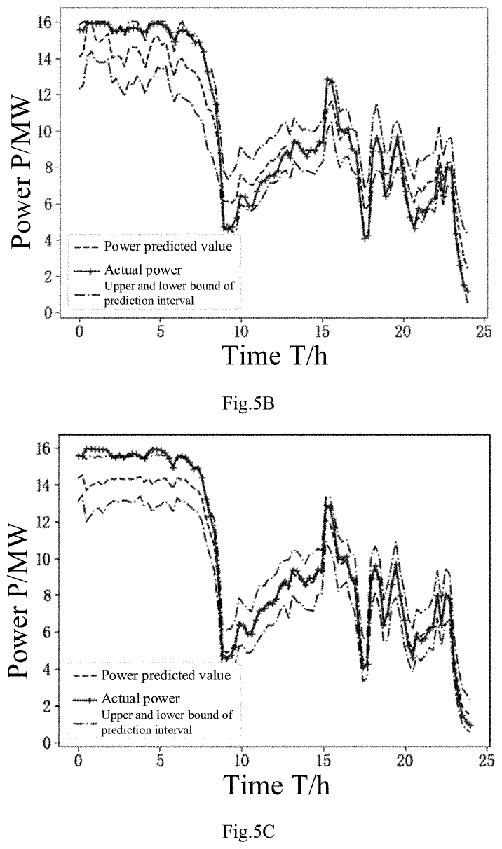

The validity of the proposed method is verified through the actual data of a wind farm in a domestic industrial park, and a data sampling interval is 15 minutes. Before establishing a prediction model, it is necessary to analyze correlation between each influencing factor and wind power output, reduce dimension of sample data, and then select wind speed, wind power and air density of the wind farm as influencing factors. It is determined that the form of a wind speed prediction model is ARMA(5,4), the form of a wind direction prediction model is ARMA(5,4), and the form of an air density prediction model is ARMA(4,4) according to an AIC minimum criterion, an autocorrelation coefficient and a partial autocorrelation coefficient. Wind power output interval prediction is performed respectively under confidence levels of 95%, 90% and 80% and with different data fluctuation characteristics (a smooth group D1 and a fluctuation group D2, at a confidence level of 80%), and comparative experiments among a multi-objective interval prediction method based on LSTM (MOPI-LSTM, method a), a Gaussian process regression interval prediction method (GP-PI, method b) and the method of the present invention are conducted, as shown in FIG. 3-FIG. 5. The prediction effects of the three methods are evaluated by using the PICP and the PINAW listed by (24) as evaluation indexes. The results of the comparative experiments are shown in Table 1, Table 2 and Table 3:

TABLE 1
Comparison of PICP and PINAW results obtained by different
algorithms at different confidence levels

| | Method of the | | | | | |
|---|---|---|---|---|---|---|
| | present invention | | Method a | | Method b | |
| Confidence | PICP | | PICP | | PICP | |
| level (%) | (%) | PINAW | (%) | PINAW | (%) | PINAW |
| 95 | 96.88 | 0.1825 | 95.78 | 0.2067 | 96.17 | 0.2014 |
| 90 | 91.67 | 0.1453 | 90.53 | 0.1610 | 91.23 | 0.1737 |
| 80 | 81.25 | 0.0986 | 81.05 | 0.1385 | 82.33 | 0.1328 |

It can be known from Table 1 that the coverage probabilities of different methods can meet the preset confidence level, and the average widths are gradually reduced with the decrease of the confidence level. Whereas at the same confidence level, compared with traditional wind power output prediction methods, the method of the present invention achieves a higher interval coverage probability, a smaller interval average width, and has a higher effectiveness.

TABLE 2
Comparison of PICP and PINAW results obtained by
different algorithms at a confidence level of 80%

| | Method of the | | | | | |
|---|---|---|---|---|---|---|
| | present invention | | Method a | | Method b | |
| | PICP | | PICP | | PICP | |
| Data set | (%) | PINAW | (%) | PINAW | (%) | PINAW |
| Smooth | 83.33 | 0.0611 | 81.47 | 0.1327 | 82.29 | 0.1592 |
| group D1 | | | | | | |
| Fluctuation | 82.25 | 0.1863 | 81.56 | 0.2134 | 80.87 | 0.2290 |
| group D2 | | | | | | |

It can be known from Table 2 that although the data with different fluctuation characteristics has a certain influence on the model proposed by the present invention, the method of the present invention achieves a higher interval coverage probability and a smaller average width for wind power output prediction with smooth variation and frequent fluctuation at a confidence level of 80%, which indicates that the method of the present invention has superiority and universality.

TABLE 3
Comparison of training time results obtained by different algorithms

| | Training prediction total time (s) | | |
|---|---|---|---|
| | Method of the | | |
| | present | | |
| Data set | invention | Method a | Method b |
| Smooth | 18.11 | 30.57 | 19.93 |
| group D1 | | | |
| Fluctuation | 19.47 | 33.14 | 20.38 |
| group D2 | | | |

On the premise of ensuring the prediction performance, the method of the present invention has obvious efficiency advantages compared with other traditional wind power output interval prediction methods. As shown in Table 3, the training process of the method of the present invention takes a shorter calculation time than the comparative methods in the comparative experiments with relative smooth characteristics and relative fluctuation characteristics.

It can be seen from the comparison that the method of the present invention can guarantee a higher interval coverage probability and a smaller interval average width at different confidence levels and with different data fluctuation characteristics, and the prediction performance is better. In addition, compared with the traditional wind power output interval prediction methods, the method of the present invention has a higher calculation efficiency.

1. A wind power output interval prediction method, comprising the following steps:
using an autoregressive moving average model (ARMA) to perform time series prediction on input influencing factors, and an ARMA(p, q) expression is shown as formula (1):
xₜ=β₀+β₁xₜ₋₁+β₂xₜ₋₂+ . . . +βₚxₜ₋ₚ+òₜ+α₁òₜ₋₁+α₂òₜ₋₂+ . . . +α_{q}ò_{t-q} (1)
where {xₜ} is a smooth time series, p represents an autoregressive order, q represents a moving average order, α is a moving average model coefficient, β is an autocorrelation coefficient, and òₜ is white noise data;
using the autocorrelation coefficient and a partial autocorrelation coefficient to perform model identification;
if the autocorrelation coefficient of the time series decreases monotonously at an exponential rate or decays to zero by oscillation, having a trailing property, and the partial autocorrelation coefficient decays to zero rapidly after p step(s), showing a truncated property, then it is determined that a form of a model is autoregressive (AR)(p);
if the autocorrelation coefficient of the time series is truncated after q steps, and the partial autocorrelation coefficient has a trailing property, then it is determined that the form of a model is moving average (MA)(q);
if the autocorrelation coefficient of the time series and the partial autocorrelation coefficient do not converge to zero rapidly after a certain moment, both having a trailing property, then it is determined that the form of a model is ARMA(p, q);
using an Akaike information criterion (AIC) to measure fitting degree of an established statistical model, and a definition thereof is shown in formula (2); determining orders p and q of a ARMA(p, q) model according to the Akaike information criterion; calculating the ARMA(p, q) model from low to high, comparing AIC values, and selecting p and q values resulting in a lowest AIC value as optimal model orders;
AIC=2k−2 ln(L) (2)
where L represents a likelihood function, and k represents a quantity of model parameters;
obtaining a point estimation of each wind power output influencing factor by prediction with an ARMA model, and obtaining a corresponding interval estimation of a superposition error; defining a point estimation prediction error ε of the ARMA model as a difference between an actual sample value Pᵣ and a model predicted value Pₚ at a certain moment, i.e.:
ε=Pᵣ−Pₚ (3)
assuming that a wind power output influencing factor prediction error is ε and follows a Gaussian probability distribution with an average value of μ and a variance of σ², which is expressed as:
ε˜N(μ,σ²) (4)
a confidence interval under a given confidence level is shown as formula (5), where σ represents a standard deviation;
querying a normal distribution table to obtain a coefficient z_{1-α/2}, and substituting the coefficient into the formula to obtain a specific interval range;
[μ−z_{1-α/2}σ,μ+z_{1-α/2}σ] (5)
μ and σ² are leading factors influencing the confidence interval in normal estimation and are determined by errors at the first n moments in order to calculate prediction error distribution at moment t+1, it is necessary to set a same weight for all errors from moment t−n+1 to moment t; it can be known from empirical analysis that the closer a moment is to a prediction moment, as an influence of an error increases, therefore, proportion of the variance of historical prediction errors is decreased exponentially with time by a normal distribution and according to an idea of exponential smoothing and an exponential weighted moving average strategy:
σₜ₊₁²=αεₜ²+(1−α)σₜ² (6)
where α is a smoothing parameter with a value range of 0 to 1, εₜ is a prediction error at moment t, and σₜ² is an error variance at moment t;
after multiple iterations, formula (6) is expressed as:
σₜ₊₁²=αεₜ²+α(1−α)εₜ₋₁²+α(1−α)²εₜ₋₂²+ . . . +α(1−α)^{t-1}ε₁²+(1−α)^{t}σ₁² (7)
where if σ₁²=ε₁², then the standard deviation is expressed as σₜ₊₁;
thus, a prediction interval of wind power output influencing factors at a confidence level of 1−α is:
[μ−z_{1-α/2}σₜ₊₁,μ+z_{1-α/2}σₜ₊₁] (8)
using a Gaussian approximation method based on an iterative expectation law and a conditional variance law to estimate an expectation and a variance of a prediction model; the expectation is used to represent a predicted value at a wind power output point, and the variance is used to describe a wind power output prediction interval, thus to approximately represent distribution of the prediction model;
giving a group of training samples D={(xᵢ, yᵢ)}ᵢ₌₁^{N}, and assuming that the statistical model for wind power output interval prediction is:
yᵢ=ƒ(xᵢ)+ε(xᵢ) (9)
where yᵢ represents a wind power target value, a random variable xᵢ={x₁ᵢ, x₂ᵢ, x₃ᵢ} represents the i^{th} input vector and is a wind power output influencing factor prediction result obtained in a previous step, ƒ(xᵢ) represents a wind power predicted value, and ε(xᵢ) represents an observation noise of the wind power target value;
using an extreme learning machine (ELM) network to obtain an output value ƒ(xᵢ) of the prediction model; according to the iterative expectation law, an estimated value of the prediction model generated at a given input vector x* is μ_{*}, and is expressed as follows:
μ_{*}=E_{x*}(E_{y*}[y*|x*])=ƒ(x*) (10)
where E(▪) represents obtaining an expectation of a variable, and y* is a final power predicted value; a hyperbolic tangent function is used as an activation function h(x) at each node of an ELM network prediction model, as shown in formula (11):
$$h ( x ) = tanh ( x ) = \frac{1 - {e}^{- b \cdot x + c}}{1 + {e}^{- b \cdot x + c}} \qquad ( 11 )$$
where b and c are parameters of the activation function, and values thereof are determined randomly; then a corresponding mathematical expression of the ELM network prediction model is shown as formula (12):
$$g ( x ) = {\sum }_{i = 1}^{l} {β}_{i} h ( x ) = {\sum }_{i = 1}^{l} {β}_{i} \frac{1 - {e}^{- {b}_{i} {x}_{i} + {c}_{i}}}{1 + {e}^{- {b}_{i} {x}_{i} + {c}_{i}}} \qquad ( 12 )$$
where βᵢ is obtained by a singular value method; therefore, an expectation value of a wind power output prediction model is finally expressed as:
$${μ}_{*} = {\sum }_{i = 1}^{l} {β}_{i} \frac{1 - {e}^{- {b}_{i} {x}_{i} + {c}_{i}}}{1 + {e}^{- {b}_{i} {x}_{i} + {c}_{i}}} \qquad ( 13 )$$
(4) prediction interval construction based on conditional variance law
obtaining a variance σ_{*}² of the wind power output prediction model according to a conditional variance law and a total variance law, as shown in formula (14):
σ_{*}²=E_{x*}[var_{y*}(y*|x*)]+var_{x*}(E_{y*}[y*|x*]) (14)
where var(▪) represents obtaining the variance of the variable; according to analysis of formula (9), it is considered that yᵢ follows a Gaussian distribution with an expectation of ƒ(xᵢ) and a variance of ε(xᵢ):
yᵢ˜N(ƒ(xᵢ),ε(xᵢ)) (15)
thus:
E_{x*}[var_{y*}(y*|x*)]=0 (16)
in addition, var_{x*}[E_{y*}(y*|x*)] is expanded as:
var_{x*}[E_{y*}(y*|x*)]=var_{x*}[E(y)]=∫[ƒ(x)−E(ƒ(x))]²p(x)dx (17)
where ƒ(x) represents a wind power fitting model established by an extreme learning machine; since the ELM network prediction model is a nonlinear model, a first-order Taylor expansion is used to perform linearized approximation thereof:
ƒ(x)=ƒ(x*)+ƒ′(x*)(x−x*)+O(∥x−x*∥²) (18)
substituting formula (18) into formula (14) to obtain the variance σ_{*}² of the wind power output prediction model, as shown in formula (19):
σ_{*}²=ƒ²(x*)+2ƒ(x*)ƒ′(x*)E(x)−2ƒ(x*)ƒ′(x*)x* +(ƒ′(x*))²(E(x)²−2x*E(x)+x²)−ƒ²(x) (19)
after the expectation and the variance of the wind power output prediction model are obtained, obtaining the wind power output prediction interval at the confidence level of 1−α according to the Gaussian distribution:
$$[ {μ}_{*} - \sqrt{\frac{{σ}_{*}^{2}}{n}} {z}_{α / 2} , {μ}_{*} + \sqrt{\frac{{σ}_{*}^{2}}{n}} {z}_{α / 2} ] \qquad ( 20 )$$
selecting a prediction interval coverage probability (PICP) and a prediction interval normalized average width (PINAW) as evaluation indexes of interval prediction results, which are defined as:
$$PICP = \frac{1}{n} {\sum }_{i = 1}^{n} {λ}_{i} , PINAW = {\sum }_{i = 1}^{n} \frac{{U}_{i} - {L}_{i}}{nR} \qquad ( 21 )$$
where n is a quantity of test samples, and R represents a maximum width of the prediction interval; λᵢ is a 0/1 variable, and a formula thereof is as follows:
$${λ}_{i} = \{ \begin{matrix}1 , & {y}_{i} ∈ [ {L}_{i} , {U}_{i} ] \\ 0 , & {y}_{i} ∉ [ {L}_{i} , {U}_{i} ]\end{matrix} \qquad ( 22 )$$
where yᵢ is a value of the test samples, Uᵢ and Lᵢ are an upper bound and a lower bound of the interval prediction results; if yᵢ is between the upper bound and the lower bound of the prediction interval, λᵢ is 1; if yᵢ falls outside the range of the prediction interval, λᵢ is 0; and
using the wind power output prediction to support operation planning of a power grid and maximize utilization of wind power through the power grid.
